(19) United States
(12) Patent Application Publication
(10) Pub. No.: US 2023/0202929 A1
(43) Pub. Date: Jun. 29, 2023

(54) TEMPERATURE STABLE, HIGH THERMAL CONDUCTIVITY AND LOW LOSS TANGENT COMPOSITE DIELECTRIC

(71) Applicant: Skyworks Solutions, Inc., Irvine, CA (US)

(72) Inventors: Michael David Hill, Emmitsburg, MD (US); Srinivas Polisetty, Frederick, MD (US)

(21) Appl. No.: 18/147,616

(22) Filed: Dec. 28, 2022

Related U.S. Application Data
(60) Provisional application No. 63/266,166, filed on Dec. 29, 2021.

(51) Int. Cl. C04B 35/10; C04B 35/626; C04B 35/64

(52) U.S. Cl. CPC C04B 35/10; C04B 35/62645; C04B 35/64; C04B 2235/3222; C04B 2235/3284; C04B 2235/3234; C04B 2235/661; C04B 2235/763; H04B 1/40

(57) ABSTRACT

The disclosed technology relates to a ceramic composition and an article formed therefrom. A ceramic article for radio frequency applications is formed of a ceramic composite material comprising a matrix phase comprising aluminum oxide having a corundum crystal structure and a precipitate phase comprising ZnAl₂O₄ and Zn₂TiO₄ and having a spinel crystal structure.

### CROSS-REFERENCE TO RELATED APPLICATION

This application claims the benefit of U.S. Provisional Application No. 63/266,166, entitled “TEMPERATURE STABLE, HIGH THERMAL CONDUCTIVITY AND LOW LOSS TANGENT COMPOSITE DIELECTRIC,” filed Dec. 29, 2021, the content of which is hereby incorporated by reference in its entirety.

### BACKGROUND

### Field

Embodiments of the disclosure generally relate to high thermal conductivity, high mechanical strength, low dielectric constant and low dielectric loss ceramic materials.

### Description of the Related Art

Many emerging applications for high dielectric materials require the dielectric material to be heated and cooled very rapidly during active use. This can lead to the possibility of thermal shock of the material, and in particular when the heating and cooling is applied to brittle monolithic polycrystalline ceramic dielectrics. Thermal shock can occur when a change in temperature forms a thermal gradient in a material, which then causes different portions of the material to expand or contract by different amounts relative to other portions of the material. This differential thermal expansion can cause increased stress and/or strain between the portions. If the stress/strain is greater than the fracture strength of the material, be it after repeated stress/strain or a high initial stress/strain, cracks can form into the material. Eventually, the cracks can lead to the structural failure of the material. Thus, thermal shock can physically damage the high dielectric material, making it unusable for its intended purpose. Moreover, thermal shock to the material can also lead to overall damage of components that the material is incorporated into.

Further, applications requiring high power levels, such as certain lighting systems, require very high thermal conductivity materials in order to function at their optimal levels. However, a significant problem is that most high thermal conductivity ceramics are expensive (e.g., diamond), extremely toxic (e.g., beryllium oxide), and/or have low dielectric constants (e.g., <6).

### SUMMARY

In one aspect, a ceramic article for radio frequency applications, the ceramic article being formed of a composite material comprising a matrix phase comprising aluminum oxide having a corundum crystal structure and a precipitate phase comprising ZnAl₂O₄ and Zn₂TiO₄, e.g., a solid solution thereof, and having a spinel crystal structure.

In another aspect, a radio frequency (RF) circulator comprises a ceramic disk formed of a ceramic material having a matrix phase comprising aluminum oxide having a corundum crystal structure, and a precipitate phase comprising ZnAl₂O₄ and Zn₂TiO₄ or a solid solution thereof and having a spinel crystal structure.

In another aspect, a method of forming a ceramic article comprises mixing component powders to form a mixed powder, calcining the mixed powder, forming the calcined mixed powder into a ceramic disk and sintering the ceramic disk. Sintering the ceramic disk is such that the ceramic a ceramic material of the ceramic disk comprises a matrix phase comprising aluminum oxide having a corundum crystal structure, and further comprises a precipitate phase comprising ZnAl₂O₄ and Zn₂TiO₄ or a solid solution thereof and having a spinel crystal structure.

### BRIEF DESCRIPTION OF THE DRAWINGS

FIG. 1 schematically shows how materials having one or more features described herein can be designed, fabricated, and used.

FIG. 2A schematically depicts a composite dielectric material including a spinel phase according to some embodiments.

FIG. 2B schematically depicts a composite dielectric material including a spinel phase according to some other embodiments.

FIG. 3 illustrates a spinel crystal lattice structure.

FIG. 4 illustrates an Al₂O₃ crystal lattice having a corundum structure.

FIG. 5 is a graph of experimentally measured X-ray diffraction spectra of composite dielectric materials including a spinel phase, according to some embodiments.

FIG. 6 is a graph of experimentally measured X-ray diffraction spectra of composite dielectric materials including a spinel phase, according to some other embodiments.

FIG. 7 is a TiO₂—ZnO-Al₂O₃ ternary phase diagram including a region with a spinel precipitate phase, according to embodiments.

FIG. 8 is a close up version of the TiO₂—ZnO-Al₂O₃ ternary phase diagram shown in FIG. 7 including experimentally measured compositions according to embodiments.

FIG. 9 illustrates an example process flow for making an embodiment of a composite dielectric having one or more features described herein.

FIG. 10 shows an example RF system where one or more of devices as described herein can be implemented.

FIG. 11 shows a process that can be implemented to fabricate a ceramic material having one or more features as described herein.

FIG. 12 shows a process that can be implemented to form a shaped object from powder material described herein.

FIG. 13 shows examples of various stages of the process of FIG. 12.

FIG. 14 shows a process that can be implemented to sinter formed objects such as those formed in the example of FIGS. 12 and 13.

FIG. 15 shows examples of various stages of the process of FIG. 13.

FIG. 16 illustrates a perspective view of a cellular antenna base station incorporating embodiments of the disclosure.

FIG. 17 illustrates housing components of a base station incorporating embodiments of the disclosed material.

FIG. 18 illustrates a cavity filter used in a base station incorporating embodiments of the material disclosed herein.

### DETAILED DESCRIPTION

Disclosed herein are embodiments of materials, such as ceramic materials, having high thermal conductivity, high mechanical strength, high Q (low loss tangent), high temperature stability, and low cost. These materials can be utilized in a number of radiofrequency (RF) devices, in particular for 5G applications, such as filters (e.g., monoblock or waveguide filters), though these are merely non-limiting examples. In particular, embodiments of a ZnO—Al₂O₃—TiO₂ ternary system can be used to form a ceramic article for radio frequency applications. The ceramic article according to embodiments is formed of a composite material comprising a matrix phase and a precipitate phase. The matrix phase may be contiguous according to some embodiments. As used herein, a matrix phase that is contiguous may surround one or more precipitate phases continuously on all sides. According to embodiments, the contiguous matrix phase comprises aluminum oxide having a corundum crystal structure and the precipitate phase comprises ZnAl₂O₄ and Zn₂TiO₄ and has a spinel crystal structure.

Embodiments of the disclosure could advantageously allow for 5G systems, in particular operating at 3 GHz and above, to form integrated architectures which can include different components, such as antennas, circulators, amplifiers, and/or semiconductor based amplifiers. By allowing for the integration of these components onto a single substrate, this can improve the overall miniaturization of the device. In some embodiments, the disclosed devices can be operable at frequencies between about 1.8 GHz and about 30 GHz. In some embodiments, the disclosed device can be operable at frequencies of about 1, 2, 3, 4, 5, 10, 15, 20, or 25 GHz. In some embodiments, the disclosed device can be operable at frequencies of greater than about 1, 2, 3, 4, 5, 10, 15, 20, or 25 GHz. In some embodiments, the disclosed device can be operable at frequencies of less than about 30, 25, 20, 15, 10, 5, 4, 3, or 2 GHz.

In some embodiments, the integrated architecture can include a directional coupler and/or isolator in a package size which is not much larger than, or the same size as, a standard isolator. In some embodiments, the integrated architecture can include a high power switch or filter. In addition to using the dielectric tile as a substrate for the impedance transformer, it could also be used as the substrate for other components.

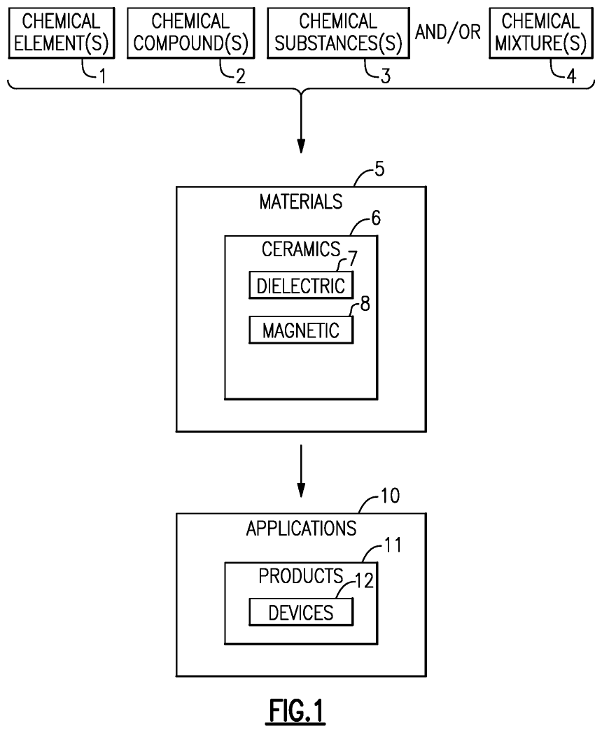

FIG. 1 schematically shows how one or more chemical elements (block 1), chemical compounds (block 2), chemical substances (block 3) and/or chemical mixtures (block 4) can be processed to yield one or more materials (block 5) having one or more features described herein. In some embodiments, such materials can be formed into ceramic materials (block 6) configured to include a desirable dielectric property (block 7), a magnetic property (block 8) and/or an advanced material property (block 9).

In some embodiments, a material having one or more of the foregoing properties can be implemented in applications (block 10) such as radio-frequency (RF) application. Such applications can include implementations of one or more features as described herein in devices 12. In some applications, such devices can further be implemented in products 11. Examples of such devices and/or products are described herein.

### Composite Ceramic Material Having Matrix and Precipitate Phases

Composite materials are materials that include two or more constituent materials. Typically, the two or more materials have different physical, performance, and/or chemical properties. Once combined, the final composite can have different physical, performance, and/or chemical properties than the individual constituent materials. In some embodiments, the individual constituent materials can remain separate in the final composite material by forming thermodynamically stable and separate phases.

Composite materials have a number of applications in the current materials space. They can be used in mortars, concretes, plastics, metals, and ceramics. Discussed herein are embodiments of composite ceramic materials.

Useful materials for applications as disclosed herein are composite materials. In some embodiments, a composite ceramic material can be formed out of two or more different phases which can be found in the same material upon stabilization. In particular, the composite ceramic can be formed from a first (or primary) phase, which can be one contiguous phase, with particles/portions/sections/regions of a secondary phase (and/or tertiary/quaternary/etc. phases) embedded within and at least partially surrounded by the contiguous phase, thereby creating a dual-phase composite material. In some embodiments, a third phase of material can be embedded into the first phase, the second phase, both phases, or can cross the phases.

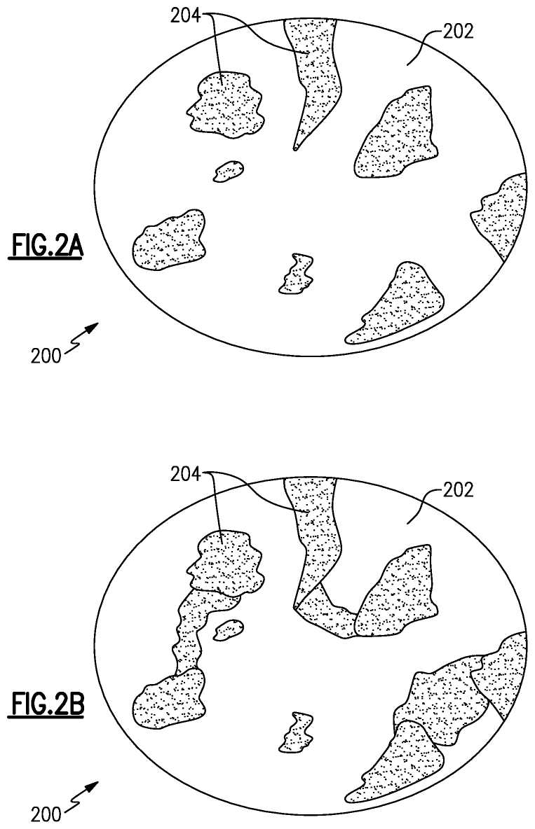

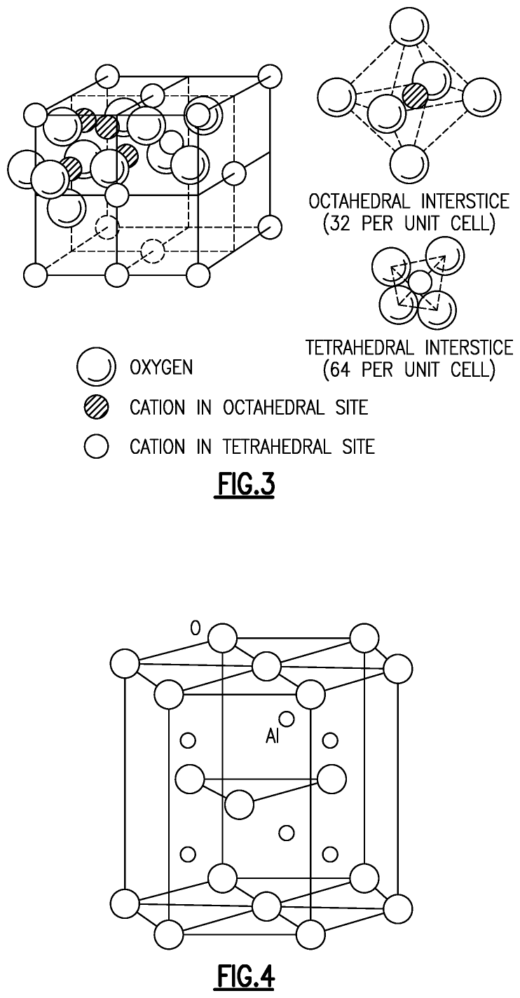

An example embodiment of such composite material is shown in FIGS. 2A-2B. As shown in FIG. 2A, the composite ceramic material 200 can have a base primary phase material 202. Further, portions of secondary phase material 204 can be scattered throughout the primary phase material 202. The scattered portions of the secondary phase material 204 can represent, e.g., individual grains of the secondary phase material 204. FIG. 2B illustrates a more connected secondary phase material 204 as compared to the embodiment of FIG. 2A. The illustrated connected portions of the secondary phase material 204 can represent, e.g., multiple grains of the secondary phase material 204. It will be appreciated that, as shown in FIGS. 2A and 2B, the primary phase material 202 may be a matrix phase that is contiguous, which may surround, e.g., continuously surround, one or more portions of the secondary phase material 204, which may be precipitate phases arranged as individual grains or multiple grains. FIGS. 2A-2B show just one example of a composite ceramic 200, and the particular location of the different phases is not limiting. The primary phase can be generally contiguous whereas the secondary phase can form isolated “islands” within the primary phase. In some embodiments, there can be two dispersed second phases existing within the primary phase. For example, they can be isolated from one another forming separate “islands” within the primary phase. However, there is a statistical possibility of the two secondary phases coming into contact with one another. In some cases, there may be a small reaction zone at the interface of the primary phase and one or more of the secondary phases.

In some embodiments, the primary phase may not be fully contiguous as the secondary phase may cut off portions of it due to various formation methods. In some embodiments, the primary phase may be fully contiguous. In some embodiments, the primary phase may be fully contiguous over a 0.1×0.1 in², 0.2×0.2 in², 0.5×0.5 in², 1×1 in², 2×2 in², 3×3 in², 4×4 in², or 5×5 in² area. As described herein, such level of contiguity can be critical for the observed enhanced thermal conductivity and mechanical strength, among other parameters, because the contiguity provides paths for efficient heat conduction. Further, the secondary phase may comprise a number of different portions within the first phase, or can be represented by a larger singular portion within the first phase.

The secondary phase can also be composed of a number of different materials, and thus the secondary phase can form with some locations having material A whereas other locations can have material B or combinations of both. In some embodiments, a location can be a majority A and in other locations can be a majority B. In some embodiments, the secondary phases can be identical to one another in structure or composition in some embodiments. In some embodiments, the secondary phases may be generally the same with minor variations/impurities. In some embodiments the secondary phases may act in generally the same or an identical manner while having compositional differences. It will be understood that while one of the phases is described as “secondary”, the particular amount of the material forming the secondary phase may be greater than, equal to, or lower than the primary phase. The particular structure of the final composite is not limiting.

In some embodiments, the composite ceramic material can be partially or fully defined by its composition. Further, these compositions can lead to a particular microstructure formation, which can be used to fully or partially define the material. The composite ceramic material can include two or more different ceramics, and may not include other materials such as metals or polymers/plastics.

In some embodiments, the use of aluminum oxide (Al₂O₃), such as alumina, has been shown to allow for advantageous properties to form the composite ceramic. Alumina and aluminum oxide can be used interchangeably herein. Alumina itself typically has a low dielectric constant, 8 (or about 8), though it has very good thermal conductivity, 30 W·m⁻¹·K⁻¹ (or about 30). Thus, aluminum oxide may be advantageous for the base material and form the primary phase in the composite material according to embodiments.

Accordingly, a two-phase ceramic material can be designed with aluminum oxide as the primary phase and particles of a second phase material with a higher dielectric constant can be incorporated into the aluminum oxide so as to create a material with a high dielectric constant and good thermal conductivity. Thus, the dispersed second phase can give the composite with alumina an overall higher dielectric constant than a pure aluminum oxide ceramic. The dielectric constant and thermal conductivity can be balanced to optimize the particular advantageous qualities of the material.

By adding the secondary phase material with a high dielectric constant to aluminum oxide and creating a two phase composite with aluminum oxide being the contiguous phase, a high thermal conductivity composite ceramic with a dielectric constant of 10 or greater may be obtained. In some embodiments, the dielectric constant can be 10 or greater (or about 10 or greater), 15 or greater (or about 15 or greater), 20 or greater (or about 20 or greater), or 25 or greater (or about 25 or greater).

In some embodiments, the material may also still exhibit high thermal conductivity, thereby reducing thermal shock. For example, the thermal conductivity can be at least as high as that of aluminum oxide by itself. Thus, the secondary phases may not negatively, or at least may not significantly negatively, affect the thermal conductivity of the material. In some embodiments, the thermal conductivity of the composite ceramic disclosed herein can be within 20% (or within about 20%), 10% (or within about 10%), 5% (or within about 5%), or 1% (or within about 1%) of the thermal conductivity of alumina. In some embodiments, the thermal conductivity of embodiments of the disclosed material can be 20 W·m⁻¹·K⁻¹ or greater (or about 20 W·m⁻¹ K⁻¹ or greater). In some embodiments, the thermal conductivity of embodiments of the disclosed material can be 30 W·m⁻¹·K⁻¹ or greater (or about 30 W·m⁻¹·K⁻¹ or greater). Thus, embodiments of the materials can be used during quick heating and cooling processes, as there is a lower possibility of thermal shock.

In some embodiments, the composite material may have a lower temperature drift of resonant frequency (τ_{F}). It can be advantageous to have a low τ_{F} to avoid any change in the dielectric constant as the material is heated. In some embodiments, the composite material can have a temperature drift of resonant frequency lower than 30 ppm/Degree (or lower than about 30 ppm/Degree), lower than 20 ppm/Degree Celsius (or lower than about 20 ppm/Degree), lower than 10 ppm/Degree Celcius (or lower than about 10 ppm/Degree).

In consideration of the above factors, according to embodiments, referring to FIGS. 2A and 2B above, the primary phase 202 forming a matrix phase comprises aluminum oxide having a corundum crystal structure, while the secondary phase 204 comprises a precipitate phase comprising ZnAl₂O₄ and/or Zn₂TiO₄ and having a spinel crystal structure. The inventors have found that, advantageously, forming the contiguous matrix phase comprising Al₂O₃ provides the relatively high thermal conductivity and mechanical strength to the composite material. However, Al₂O₃ has a relatively low dielectric constant and negative temperature coefficient of resonant frequency. The inventors have found that, advantageously, forming the interspersed precipitate phase comprising ZnAl₂O₄ and Zn₂TiO₄ and having a spinel crystal structure improves upon some of the limitations of Al₂O₃ including the low dielectric constant and negative temperature coefficient. ZnAl₂O₄ and Zn₂TiO₄ can be present as a mechanical mixture, chemical mixture, a solid solution, or both. At least some of ZnAl₂O₄ and Zn₂TiO₄ form a solid solution. As described herein, a mixture or a solid solution of ZnAl₂O₄ and Zn₂TiO₄ is described as a material or a phase which includes ZnAl₂O₄ and Zn₂TiO₄. The resulting composite ceramic material provides the desirable higher dielectric constant and higher temperature coefficient of resonant frequency, while retaining the higher thermal conductivity and mechanical strength of Al₂O₃ forming the matrix phase.

### Thermodynamically Stable Matrix and Precipitate Phases

As discussed above, the inventors have found that the contiguous matrix phase comprising Al₂O₃ provides the relatively high thermal conductivity and mechanical strength to the composite material. In addition, forming the interspersed precipitate phase comprising ZnAl₂O₄ and Zn₂TiO₄ and having a spinel crystal structure improves upon some of the limitations of Al₂O₃ including the low dielectric constant and negative temperature coefficient.

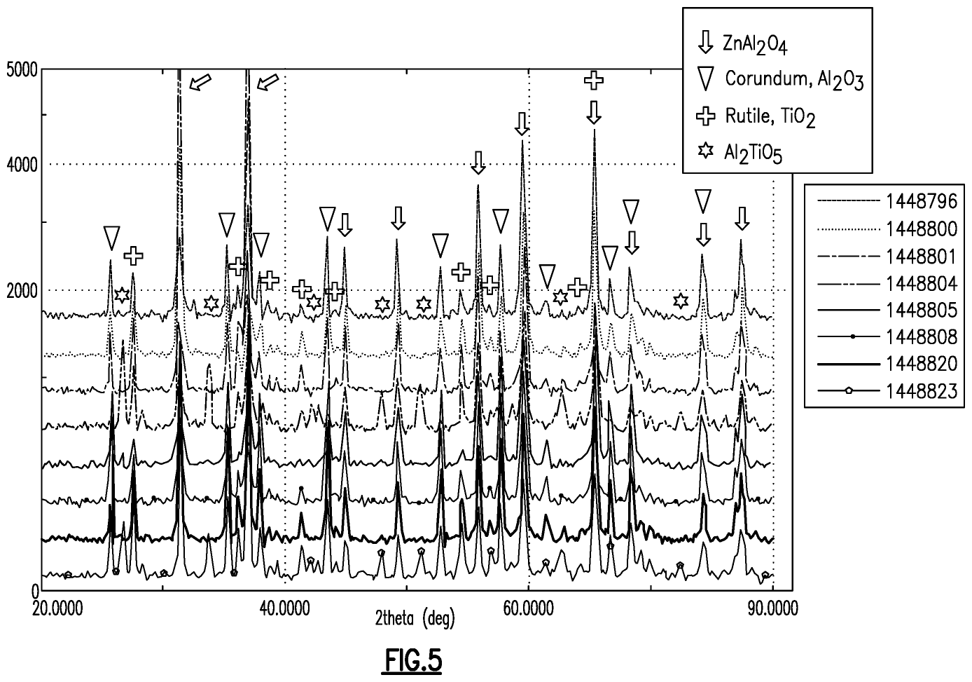

FIG. 3 illustrates a spinel crystal lattice structure and FIG. 4 illustrates an Al₂O₃ crystal lattice having a corundum structure. As described herein, a spinel crystal structure refers to the structure of some oxides having the general formula AB₂O₄, having a cubic structure which can be viewed as a combination of the rock salt and zinc Mende structures. For ZnAl₂O₄ and Zn₂TiO₄, A=Zn and Ti, respectively, and B=Al and Zn, respectively. The oxygen ions are in face-centered cubic close packing. As shown in FIG. 3, for a subcell of this structure there are four atoms, four octahedral interstices, and eight tetrahedral interstices. This makes a total of twelve interstices to be filled by three cations, one divalent and two trivalent. In each elementary cell two octahedral sites are filled and one tetrahedral. Eight of these elementary cells are arranged so as to form a unit cell containing 32 oxygen ions, 16 octahedral cations, and 8 tetrahedral cations. The A²⁺ ions are on tetrahedral sites and the B³⁺ ions are on octahedral sites.

As described above, according to some embodiments, at least some of ZnAl₂O₄ and Zn₂TiO₄ may be present in the form of a solid solution. When present as a solid solution, adjacent unit cells may be randomly arranged such that Zn and Ti interchangeably occupy the A sites of adjacent unit cells, and Al and Zn interchangeably occupy the B sites of adjacent unit cells. This is distinguishable from a mixture, in which adjacent unit cells may substantially be either ZnAl₂O₄ unit cells or Zn₂TiO₄ unit cells.

In Al₂O₃, the preferred coordination for is so that with a valence of there is bond strength this requires four Al³⁺ adjacent each O²⁻. This is achieved hexagonal close packing of the oxygen ions, with aluminum ions two-thirds the octahedral Subsequent similar are such that maximum of the Al³⁺ ions is achieved.

The inventors have further found that, while the presence of phases having complementary properties provides the synergistic mechanical and electrical properties as described above, some phases are not thermodynamically stable with respect to each other. In particular, the inventors have found that, while the precipitate phase comprising ZnAl₂O₄ and Zn₂TiO₄ and the matrix phase comprising Al₂O₃ can be thermodynamically stable against one another, the presence of additional materials may lead to formation of undesirable phases. For example, the inventors have found that, when an excessive amount of TiO₂ is present in the component powder mixture, it may undesirably react with Al₂O₃ to form Al₂TiO₅, which have been found to lead to one or more of lower dielectric constant, lower temperature coefficient of resonant frequency, lower thermal conductivity and/or lower mechanical strength in the resulting composite ceramic material.

Table I below illustrates starting powder compositions including zinc aluminum titanate (e.g., Zn₁₊ₓAl₂₋₂ₓTiₓO₄), Al₂O₃ and TiO₂, fired at 1315° C., and the resulting density, dielectric constant and the Q factor, according to embodiments.

TABLE I
Example Starting Powder Compositions and Resulting Properties of Composite Ceramics Formed at 1315° C.

| Batch specifications | | Components | | | Components | | | | |
|---|---|---|---|---|---|---|---|---|---|
| jobNumber | QCMS No. | ZTA (gr) | Al₂O₃ (gr) | TiO₂ (gr) | ZTA (%) | Al₂O₃ (%) | TiO₂ (%) | XRD | Microstructure |
| MH19-41-1 | 1448794 | 45 | 15 | | 75.00 | 25.00 | 0.00 | | Yes |
| MH19-41-2 | 1448795 | 45 | 15 | 0.3 | 74.63 | 24.88 | 0.50 | | Yes |
| MH19-41-3 | 1448796 | 45 | 15 | 0.6 | 74.26 | 24.75 | 0.99 | Yes | |
| MH19-41-4 | 1448797 | 45 | 15 | 1.2 | 73.53 | 24.51 | 1.96 | | |
| MH19-41-5 | 1448798 | 45 | 15 | 1.8 | 72.82 | 24.27 | 2.91 | | |
| MH19-41-6 | 1448800 | 45 | 15 | 2.4 | 72.12 | 24.04 | 3.85 | Yes | |
| MH19-41-7 | 1448801 | 45 | 15 | 3 | 71.43 | 23.81 | 4.76 | Yes | |
| MH19-41-8 | 1448802 | 45 | 15 | 6 | 68.18 | 22.73 | 9.09 | | Yes |
| MH19-41-9 | 1448803 | 45 | 15 | 9 | 65.22 | 21.74 | 13.04 | | Yes |
| MH19-41-10 | 1448804 | 45 | 15 | 12 | 62.50 | 20.83 | 16.67 | Yes | |
| MH19-41-11 | 1448805 | 30 | 30 | | 50.00 | 50.00 | 0.00 | Yes | |
| MH19-41-12 | 1448806 | 30 | 30 | 0.3 | 49.75 | 49.75 | 0.50 | | Yes |
| MH19-41-13 | 1448807 | 30 | 30 | 0.6 | 49.50 | 49.50 | 0.99 | | |
| MH19-41-14 | 1448808 | 30 | 30 | 1.2 | 49.02 | 49.02 | 1.96 | Yes | |
| MH19-41-15 | 1448812 | 30 | 30 | 1.8 | 48.54 | 48.54 | 2.91 | | |
| MH19-41-16 | 1448819 | 30 | 30 | 2.4 | 48.08 | 48.08 | 3.85 | | |
| MH19-41-17 | 1448820 | 30 | 30 | 3 | 47.62 | 47.62 | 4.76 | Yes | |
| MH19-41-18 | 1448821 | 30 | 30 | 6 | 45.45 | 45.45 | 9.09 | | Yes |
| MH19-41-19 | 1448822 | 30 | 30 | 9 | 43.48 | 43.48 | 13.04 | | Yes |
| MH19-41-20 | 1448823 | 30 | 30 | 12 | 41.67 | 41.67 | 16.67 | Yes | |

| | | Components | | | Components | | | Electricals | | | |
|---|---|---|---|---|---|---|---|---|---|---|---|
| Batch specifications | | ZTA | Al₂O₃ | TiO₂ | ZTA | Al₂O₃ | TiO₂ | | Dielectric | Q | [symbol] f |
| jobNumber | QCMS No. | (gr) | (gr) | (gr) | (%) | (gr) | (%) | Density | E′ | Factor | lin(25 C.-60 C. [symbol] |
| MH19-41-1 | 1448794 | 45 | 15 | | 75.00 | 25.00 | 0.00 | 3.77 | 7.78 | 3020 | −48.38 |
| MH19-41-2 | 1448795 | 45 | 15 | 0.3 | 74.63 | 24.88 | 0.50 | 3.8 | 7.95 | 2922 | |
| MH19-41-3 | 1448796 | 45 | 15 | 0.6 | 74.26 | 24.75 | 0.99 | 3.84 | 8.14 | 2948 | −47.55 |
| MH19-41-4 | 1448797 | 45 | 15 | 1.2 | 73.53 | 24.51 | 1.96 | | | | |
| MH19-41-5 | 1448798 | 45 | 15 | 1.8 | 72.82 | 24.27 | 2.91 | | | | |
| MH19-41-6 | 1448800 | 45 | 15 | 2.4 | 72.12 | 24.04 | 3.85 | 3.88 | 8.85 | 4159 | −36.3 |
| MH19-41-7 | 1448801 | 45 | 15 | 3 | 71.43 | 23.81 | 4.76 | 3.83 | 8.88 | 2255 | −32.34 |
| MH19-41-8 | 1448802 | 45 | 15 | 6 | 68.18 | 22.73 | 9.09 | 3.77 | 9.45 | 2187 | |
| MH19-41-9 | 1448803 | 45 | 15 | 9 | 65.22 | 21.74 | 13.04 | 3.68 | 9.4 | 2409 | |
| MH19-41-10 | 1448804 | 45 | 15 | 12 | 62.50 | 20.83 | 16.67 | 3.63 | 9.98 | 2349 | −33.42 |
| MH19-41-11 | 1448805 | 30 | 30 | | 50.00 | 50.00 | 0.00 | 3.81 | 8.52 | 3003 | −48.27 |
| MH19-41-12 | 1448806 | 30 | 30 | 0.3 | 49.75 | 49.75 | 0.50 | 3.87 | 8.79 | 2170 | |
| MH19-41-13 | 1448807 | 30 | 30 | 0.6 | 49.50 | 49.50 | 0.99 | 3.82 | 8.74 | 2380 | |
| MH19-41-14 | 1448808 | 30 | 30 | 1.2 | 49.02 | 49.02 | 1.96 | 3.9 | 9.24 | 2441 | −41.82 |
| MH19-41-15 | 1448812 | 30 | 30 | 1.8 | 48.54 | 48.54 | 2.91 | 3.89 | 9.42 | 2229 | |
| MH19-41-16 | 1448819 | 30 | 30 | 2.4 | 48.08 | 48.08 | 3.85 | 3.86 | 9.52 | 2310 | |
| MH19-41-17 | 1448820 | 30 | 30 | 3 | 47.62 | 47.62 | 4.76 | 3.91 | 10.01 | 3270 | −28.28 |
| MH19-41-18 | 1448821 | 30 | 30 | 6 | 45.45 | 45.45 | 9.09 | 3.82 | 11.2 | 2736 | |
| MH19-41-19 | 1448822 | 30 | 30 | 9 | 43.48 | 43.48 | 13.04 | 3.69 | 11.85 | 2548 | |
| MH19-41-20 | 1448823 | 30 | 30 | 12 | 41.67 | 41.67 | 16.67 | 3.62 | 11.93 | 2518 | 23.95 |

[symbol]

indicates data missing or illegible when filed

Table II below illustrates starting powder compositions including zinc aluminum titanate (e.g., Zn₁₊ₓAl₂₋₂ₓ TiₓO₄), Al₂O₃ and TiO₂, fired at 1385° C., and the resulting density, dielectric constant and the Q factor, according to embodiments.

TABLE II
Example Starting Powder Compositions and Resulting Properties of Composite Ceramics Formed at 1385° C.

| Batch specifications | | Components | | | Components | | | | |
|---|---|---|---|---|---|---|---|---|---|
| jobNumber | QCMS No. | ZTA (gr) | Al₂O₃ (gr) | TiO₂ (gr) | ZTA (%) | Al₂O₃ (gr) | TiO₂ (%) | XRD | Microstructure |
| MH19-41-1 | 1449083 | 45 | 15 | 0 | 75.00 | 25.00 | 0.00 | Yes | Yes |
| MH19-41-2 | 1449084 | 45 | 15 | 0.3 | 74.63 | 24.88 | 0.50 | Yes | |
| MH19-41-3 | 1449085 | 45 | 15 | 0.3 | 74.63 | 24.88 | 0.50 | Yes | |
| MH19-41-4 | 1449087 | 45 | 15 | 1.2 | 73.53 | 24.51 | 1.96 | Yes | |
| MH19-41-5 | 1449088 | 45 | 15 | 1.8 | 72.82 | 24.27 | 2.91 | Yes | |
| MH19-41-6 | 1449089 | 45 | 15 | 2.4 | 72.12 | 24.04 | 3.85 | Yes | |
| MH19-41-7 | 1449090 | 45 | 15 | 3 | 71.43 | 23.81 | 4.76 | Yes | |
| MH19-41-8 | 1449091 | 45 | 15 | 6 | 68.18 | 22.73 | 9.09 | Yes | |
| MH19-41-9 | 1449092 | 45 | 15 | 9 | 65.22 | 21.74 | 13.04 | Yes | |
| MH19-41-10 | 1449093 | 45 | 15 | 12 | 62.50 | 20.83 | 16.67 | Yes | Yes |
| MH19-41-11 | 1449094 | 30 | 30 | 0 | 50.00 | 50.00 | 0.00 | Yes | Yes |
| MH19-41-12 | 1449097 | 30 | 30 | 0.3 | 49.75 | 49.75 | 0.50 | Yes | |
| MH19-41-13 | 1449098 | 30 | 30 | 0.6 | 49.50 | 49.50 | 0.99 | Yes | |
| MH19-41-14 | 1449099 | 30 | 30 | 1.2 | 49.02 | 49.02 | 1.96 | Yes | |
| MH19-41-15 | 1449100 | 30 | 30 | 1.8 | 48.54 | 48.54 | 2.91 | Yes | |
| MH19-41-16 | 1449101 | 30 | 30 | 2.4 | 48.08 | 48.08 | 3.85 | Yes | |
| MH19-41-17 | 1449102 | 30 | 30 | 3 | 47.62 | 47.62 | 4.76 | Yes | |
| MH19-41-18 | 1449103 | 30 | 30 | 6 | 45.45 | 45.45 | 9.09 | Yes | |
| MH19-41-19 | 1449104 | 30 | 30 | 9 | 43.48 | 43.48 | 13.04 | Yes | |
| MH19-41-20 | 1449105 | 30 | 30 | 12 | 41.67 | 41.67 | 16.67 | Yes | Yes |

| Batch specifications | | Components | | | Components | | | Electricals | | |
|---|---|---|---|---|---|---|---|---|---|---|
| jobNumber | QCMS No. | ZTA (gr) | Al₂O₃ (gr) | TiO₂ (gr) | ZTA (%) | Al₂O₃ (%) | TiO₂ (%) | Density | Dielectric E′ | Q Factor |
| MH19-41-1 | 1449083 | 45 | 15 | 0 | 75.00 | 25.00 | 0.00 | 4.21 | 9.05 | 1939 |
| MH19-41-2 | 1449084 | 45 | 15 | 0.3 | 74.63 | 24.88 | 0.50 | 4.19 | 9.14 | 2039 |
| MH19-41-3 | 1449085 | 45 | 15 | 0.3 | 74.63 | 24.88 | 0.50 | 4.23 | 9.34 | 2007 |
| MH19-41-4 | 1449087 | 45 | 15 | 1.2 | 73.53 | 24.51 | 1.96 | 4.16 | 9.36 | 2173 |
| MH19-41-5 | 1449088 | 45 | 15 | 1.8 | 72.82 | 24.27 | 2.91 | 4.21 | 9.67 | 3579 |
| MH19-41-6 | 1449089 | 45 | 15 | 2.4 | 72.12 | 24.04 | 3.85 | 4.13 | 9.63 | 2373 |
| MH19-41-7 | 1449090 | 45 | 15 | 3 | 71.43 | 23.81 | 4.76 | 4.04 | 9.56 | 2792 |
| MH19-41-8 | 1449091 | 45 | 15 | 6 | 68.18 | 22.73 | 9.09 | 3.91 | 9.44 | 2677 |
| MH19-41-9 | 1449092 | 45 | 15 | 9 | 65.22 | 21.74 | 13.04 | 3.8 | 9.54 | 1936 |
| MH19-41-10 | 1449093 | 45 | 15 | 12 | 62.50 | 20.83 | 16.67 | 3.85 | 10.67 | 2204 |
| MH19-41-11 | 1449094 | 30 | 30 | 0 | 50.00 | 50.00 | 0.00 | 4.05 | 9.28 | 1324 |
| MH19-41-12 | 1449097 | 30 | 30 | 0.3 | 49.75 | 49.75 | 0.50 | 4.05 | 9.46 | 1060 |
| MH19-41-13 | 1449098 | 30 | 30 | 0.6 | 49.50 | 49.50 | 0.99 | 3.97 | 9.33 | 2635 |
| MH19-41-14 | 1449099 | 30 | 30 | 1.2 | 49.02 | 49.02 | 1.96 | 4.04 | 9.84 | 2146 |
| MH19-41-15 | 1449100 | 30 | 30 | 1.8 | 48.54 | 48.54 | 2.91 | 4 | 9.93 | 2111 |
| MH19-41-16 | 1449101 | 30 | 30 | 2.4 | 48.08 | 48.08 | 3.85 | 3.94 | 10.11 | 389 |
| MH19-41-17 | 1449102 | 30 | 30 | 3 | 47.62 | 47.62 | 4.76 | 4.01 | 10.43 | 1932 |
| MH19-41-18 | 1449103 | 30 | 30 | 6 | 45.45 | 45.45 | 9.09 | 3.92 | 10.91 | 2535 |
| MH19-41-19 | 1449104 | 30 | 30 | 9 | 43.48 | 43.48 | 13.04 | 3.72 | 10.69 | 2890 |
| MH19-41-20 | 1449105 | 30 | 30 | 12 | 41.67 | 41.67 | 16.67 | 3.56 | 10.12 | 2471 |

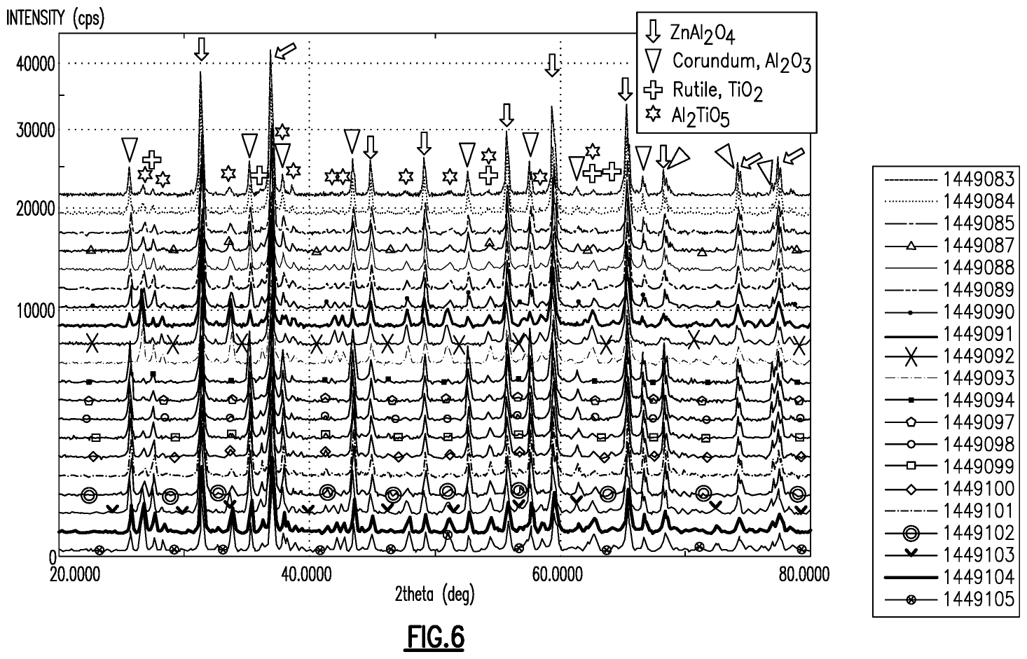

FIG. 5 is a graph of experimentally measured X-ray diffraction (XRD) spectra of selected composite dielectric materials including a spinel phase listed in Table I, according to some embodiments. In particular, the illustrated spectra correspond to the samples marked “YES” in the XRD column. As shown, the peaks corresponding to the undesirable Al₂TiO₅ phase become pronounced at 1315° C. when the weight percentage of TiO₂ exceeds about 13 weight % for the tested composition range.

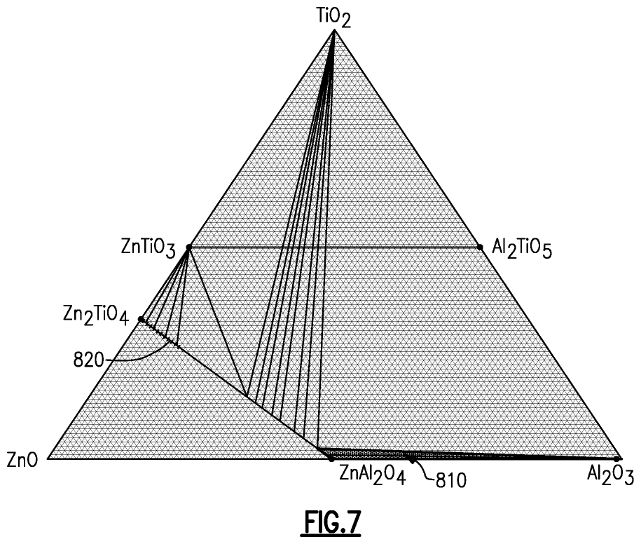

FIG. 6 is a graph of experimentally measured X-ray diffraction (XRD) spectra of selected composite dielectric materials including a spinel phase, according to some other embodiments. In particular, the illustrated spectra correspond to the samples marked “YES” in the XRD column. As shown, the peaks corresponding to the undesirable Al₂TiO₅ phase become pronounced at 1385° C. when the weight percentage of TiO₂ exceeds about 1 weight % for the tested composition range.

FIGS. 5 and 6 show that the presence of the Al₂TiO₅ phase is directly correlated to the presence of the initial excess TiO₂ powder. Thus, according to embodiments, the weight fraction of excess TiO₂ in the starting powder mixture is kept below 15%, 13%, 11%, 9%, 7%, 5%, 3%, 1% in weight percentages, or a value in a range defined by any of these values, according to embodiments.

Advantageously, the composite materials according to embodiments are thermally stable up to at least 1315° C. or 1385° C., where the matrix phase including Al₂O₃ and the precipitate phase including ZnAl₂O₄ and Zn₂TiO₄ substantially do not further react after firing at these temperature. Thus, the illustrated XRD spectra represent the actual final XRD spectra.

ZnO—Al₂O₃—TiO₂ Systems with Low Rutile Content

Disclosed herein are embodiments of temperature-stable materials with low dielectric constants. In particular, embodiments of the disclosed materials can include an ultra-low loss tangent, and can generally have a dielectric constant below 12 (or below about 12). These materials can be particularly advantageous as filters, such as monoblock filters and waveguide filters. In some embodiments, the materials can be incorporated into filters. In some embodiments, the materials can be incorporated into mm-wave dielectric filters. In some embodiments, the materials can be incorporated into resonators, isolators, or circulators. The components can be used for 5G applications, as well as other applications.

Most current materials either have low loss tangents but are not temperature stable (alumina), or are temperature stable but have high loss tangents (forsterite or spinel composites with calcium titanate). However, embodiments of the disclosure can simultaneously show good temperature stability along with low loss tangents. This could make the materials advantageous for a number of applications, such as, for example, 1) co-axial resonators over a specific frequency range, for example 1-10 GHz; 2) 5G (for example mm-wave) dielectric filters (e.g., monoblock or waveguide filters); and 3) co-firing with high magnetization nickel zinc ferrite spinels, such as for the formation of isolators or circulators.

Typically, previous solutions have either utilized materials having only a low loss tangent and dealt with the poor temperature stability, or if temperature stability was important, combinations of moderate Q forsterite or magnesium aluminate spinel along with a lossy material, such as calcium titanate, was used.

In some embodiments, a ZnO—Al₂O₃—TiO₂ ternary system can be used to form the advantageous material. As discussed above, according to embodiments, the precipitate phase comprising ZnAl₂O₄ and Zn₂TiO₄ can be thermodynamically stable with the matrix phase comprising Al₂O₃ under some circumstances, e.g., when the excess Ti or TiO₂ content in the starting powder is relatively low.

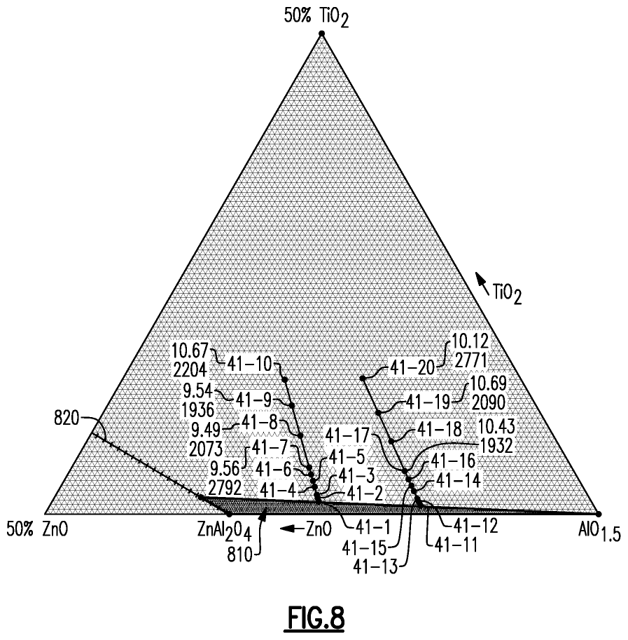

FIG. 7 is a TiO₂—ZnO-Al₂O₃ ternary phase diagram including a region with a spinel precipitate phase, according to embodiments. As illustrated, the ternary phase diagram is characterized by corner compositions represented by TiO₂, ZnO and Al₂O₃. The Al₂TiO₅ phase is disposed between TiO₂ and Al₂O₃ end phases, ZnTiO₃ and ZnTiO₄ phases are disposed between TiO₂ and ZnO end phases, and ZnAl₂O₄ phase is disposed between ZnO and Al₂O₃ end phases. The line 820 connecting the ZnAl₂O₄ and Zn₂TiO₄ end phases represent a solid solution line in which the two end phases form a solid solution represented by Zn₁₊ₓAl₂₋₂ₓTiₓO₄. A composite material having a first phase comprising Al₂O₃ and a second phase comprising ZnAl₂O₄ and Zn₂TiO₄, e.g., a solid solution thereof, can be represented by a triangular region defined by ZnAl₂O₄, Zn₂TiO₄ and Al₂O₃ as end phases. Within this region, the precipitate phase of the composite material has a composition along the straight line connecting the ZnAl₂O₄ and Zn₂TiO₄ end phases. Thus, according to embodiments, the composite material according to embodiments have a composition in this triangular region.

Of the triangular region defined by ZnAl₂O₄, Zn₂TiO₄ and Al₂O₃ as end phases, the inventors have found that, when the solid solution Zn₁₊ₓAl₂₋₂ₓTiₓO₄ is ZnAl₂O₄-rich, the resulting composite material can be made to contain particularly small amounts of the undesirable pseudobrookite Al₂TiO₅ phase. In particular, when the composition is within the relatively narrow triangular region 810, the inventors have found that the resulting composite material is essentially free of Al₂TiO₅, which has been demonstrated to be desirable from the perspective of the various electrical and mechanical properties described above. Without limitation, the triangular region 810 can represent a preferred embodiment. However, embodiments are not so limited an the composite material according to various embodiments can include any larger triangular region represented by the three end phases including ZnAl₂O₄, Al₂O₃ and any composition along the solid solution line 820 corresponding to Zn₁₊ₓAl₂₋₂ₓTiₓO₄.

The triangular region 810 can be defined by ZnAl₂O₄ and Al₂O₃ as two corners or end phases, with the third corner or end phase being a ZnAl₂O₄-rich solid solution phase Zn₁₊ₓAl₂₋₂ₓTiₓO₄. According to embodiments, the third corner of ZnAl₂O₄-rich solid solution phase Zn₁₊ₓAl₂₋₂ₓTiₓO₄ can correspond to an x value less than 0.5, 0.4, 0.3, 0.2, 0.1, 0.05 or a value in a range defined by any of these values.

According to embodiments, the composite material within the triangular region 810 has a matrix phase including Al₂O₃ having a corundum crystal structure and a precipitate phase including ZnAl₂O₄ and Zn₂TiO₄, e.g., a solid solution of ZnAl₂O₄ and Zn₂TiO₄ having a chemical formula represented by Zn₁₊ₓAl₂₋₂ₓTiₓO₄ and having a spinel crystal structure. The precipitate phase of Zn₁₊ₓAl₂₋₂ₓTiₓO₄ has an x value less than 0.4, 0.3, 0.2, 0.1, 0.05 or a value in a range defined by any of these values. According to some embodiments, the matrix phase of Al₂O₃ forms a contiguous phase surrounding the precipitate phase comprising Zn₁₊ₓAl₂₋₂ₓTiₓO₄.

In the triangular region 810, the composite material advantageously has a relatively low amount of Al₂TiO₅. According to embodiments, the amount of the Al₂TiO₅ phase in the composite material is less than 20%, 15%, 10%, 5%, 2%, 1%, or a value in a range defined by any of these values, on the basis of the total weight of the composite material. In some embodiments, the composite material is substantially free (e.g., <5 weight %) of AlTiO₅.

In the triangular region 810, the composite material advantageously is relatively free of TiO₂ having rutile structure. According to embodiments, the amount of the TiO₂ phase in the composite material is less than 20%, 15%, 10%, 5%, 2%, 1%, or a value in a range defined by any of these values, on the basis of the total weight of the composite material. In some embodiments, the composite material is substantially free (e.g., <5 weight %) of TiO₂.

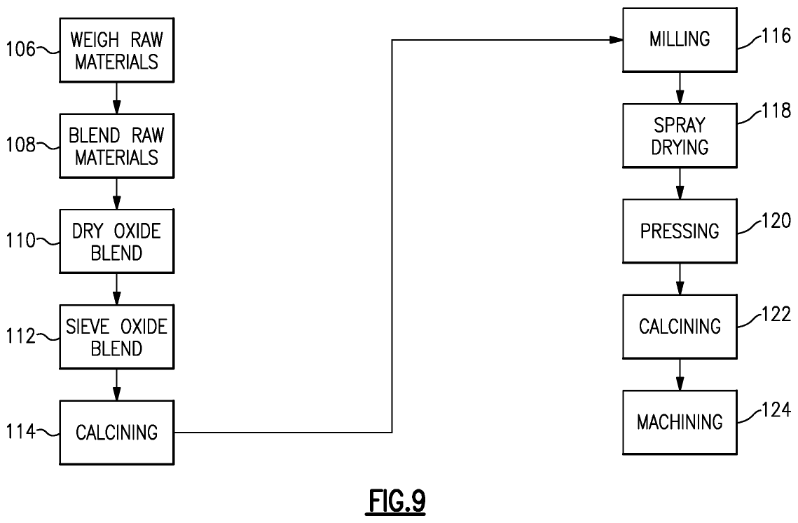

FIG. 8 is a close-up view of the TiO₂—ZnO-Al₂O₃ ternary phase diagram shown in FIG. 7 including experimentally measured compositions along lines as shown. The close-up view of FIG. 8 shows 50% ZnO and 50% TiO₂ and Al₂O₃ as end phases. Some of the experimentally measured compositions plotted in FIG. 7 correspond to experimentally verified compositions described above with respect to FIGS. 5 and 6. As illustrated by FIGS. 5 and 6 and Tables I and II, along the experimental lines, as the composition gets closer to the triangular region 810, the X-ray peaks corresponding to TiO₂ and AlTiO₅ become less and less pronounced.

### Preparation of the Composite Ceramic:

The preparation of the composite materials can be accomplished by using suitable ceramic processing techniques. One particular example of the process flow is illustrated in FIG. 9.

As shown in FIG. 9, the process begins with step 106 for weighing the raw material. The raw material may include oxides having any combination of the metal elements of the composite material, including Zn, Al and Ti. In some embodiments, the raw material can include zinc oxide (e.g., ZnO), titanium oxide (e.g., TiO₂), aluminum oxide (Al₂O₃), or combinations thereof. In some other embodiments, the raw material can include one or more of ZnAl₂O₄, Zn₂TiO₄ and/or Zn₁₊ₓAl₂₋₂ₓTiₓO₄. In addition, organic based materials may be used in a sol gel process for ethoxides and/or acrylates or citrate based techniques may be employed. Other known methods in the art such as co-precipitation of hydroxides, sol-gel, or laser ablation may also be employed as a method to obtain the materials. The amount and selection of raw material depend on the specific formulation.

After the raw materials are weighed, they are blended in Step 108 using methods consistent with the current state of the ceramic art, which can include aqueous blending using a mixing propeller, or aqueous blending using a vibratory mill with steel or zirconia media. In some embodiments, a glycine nitrate or spray pyrolysis technique may be used for blending and simultaneously reacting the raw materials.

The blended oxide is subsequently dried in Step 110, which can be accomplished by pouring the slurry into a pane and drying in an oven, preferably between 100-400° C. or by spray drying, or by other techniques known in the art.

The dried oxide blend is processed through a sieve in Step 112, which homogenizes the powder and breaks up soft agglomerates that may lead to dense particles after calcining.

The material is subsequently processed through a pre-sintering calcining in Step 114. Preferably, the material is loaded into a container such as an alumina or cordierite sagger and heat treated in the range of about 800-1000° C. In some embodiments, a heat treatment in the range of about 500-1000° C. can be used. In some embodiments, a heat treatment in the range of about 900-950° C. can be used. In some embodiments, a heat treatment in the range of about 500-700° C. can be used. Preferably, the firing temperature is low as higher firing temperatures have an adverse effect on linewidth.

After calcining, the material is milled in Step 116, preferably in a vibratory mill, an attrition mill, a jet mill or other standard comminution technique to reduce the median particle size into the range of about 0.01 to 0.1 microns, though in some embodiments larger sizes such as 0.5 micron to 10 microns can be used as well. Milling is preferably done in a water based slurry but may also be done in ethyl alcohol or another organic based solvent.

The material is subsequently spray dried in Step 118. During the spray drying process, organic additives such as binders and plasticizers can be added to the slurry using techniques known in the art. The material is spray dried to provide granules amenable to pressing, preferably in the range of about 10 microns to 150 microns in size.

The spray dried granules are subsequently pressed in Step 120, preferably by uniaxial or isostatic pressing to achieve a pressed density to as close to 60% of the x-ray theoretical density as possible. In addition, other known methods such as tape casting, tape calendaring or extrusion may be employed as well to form the unfired body.

The pressed material is subsequently processed through a calcining process in Step 122. Preferably, the pressed material is placed on a setter plate made of material such as alumina which does not readily react with the composite material. The setter plate is heated in a periodic kiln or a tunnel kiln in air or pressure oxygen in the range of between about 850° C.-1000° C. to obtain a dense ceramic compact. In some embodiments, a heat treatment in the range of about 500-1000° C. can be used. In some embodiments, a heat treatment in the range of about 500-700° C. can be used. Other known treatment techniques, such as induction heat, hot pressing, fast firing, or assisted fast firing, may also be used in this step. In some embodiments, a density having >98% of the theoretical density can be achieved.

The dense ceramic compact is machined in the Step 124 to achieve dimensions suitable or the particular applications.

### Devices Incorporating Composite Ceramic Materials

Radio-frequency (RF) applications that utilize composite compositions, such as those disclosed above for filters or antennas. It will be understood that at least some of the compositions, devices, and methods described in reference above can be applied to such implementations.

Some design considerations for achieving such features are now described. Also described are example devices and related RF performance comparisons. Also described are example applications of such devices, as well as fabrication examples.

Values of dielectric constant for microwave composites and spinels commonly fall in a range of 12 to 18 for dense polycrystalline ceramic materials.

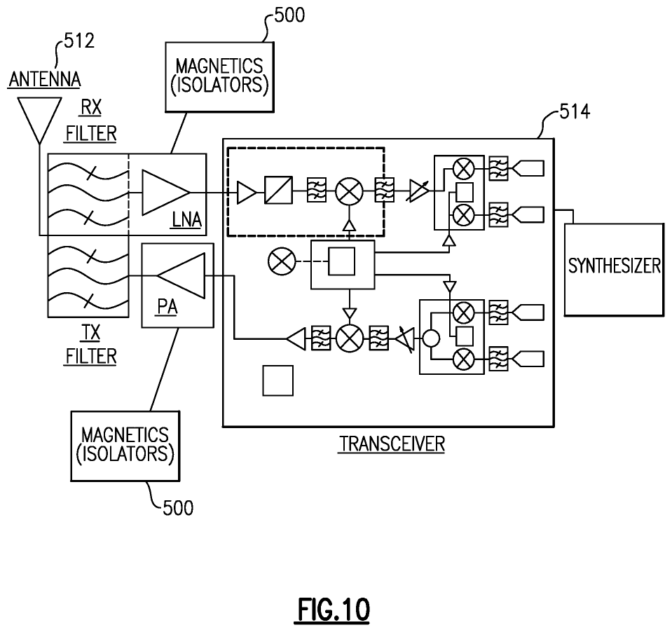

In some embodiments, the foregoing example circuit board can include RF circuits associated with a front-end module of an RF apparatus. As shown in FIG. 10, such an RF apparatus can include an antenna 512 that is configured to facilitate transmission and/or reception of RF signals. Such signals can be generated by and/or processed by a transceiver 514. For transmission, the transceiver 514 can generate a transmit signal that is amplified by a power amplifier (PA) and filtered (Tx Filter) for transmission by the antenna 512. For reception, a signal received from the antenna 512 can be filtered (Rx Filter) and amplified by a low-noise amplifier (LNA) before being passed on to the transceiver 514. In the example context of such Tx and Rx paths, circulators and/or isolators 500 having one or more features as described herein can be implemented at or in connection with, for example, the PA circuit and the LNA circuit.

In some embodiments, circuits and devices having one or more features as described herein can be implemented in RF applications such as a wireless base-station. Such a wireless base-station can include one or more antennas 512, such as the example described in reference to FIG. 10, configured to facilitate transmission and/or reception of RF signals. Such antenna(s) can be coupled to circuits and devices having one or more circulators/isolators as described herein.

### Fabrication of RF Devices

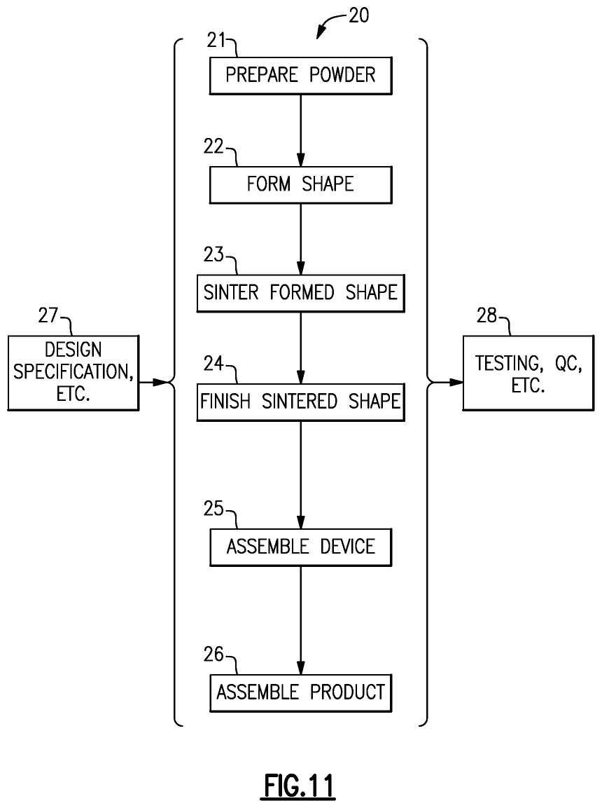

FIGS. 11-15 show examples of how composite devices having one or more features as described herein can be fabricated. FIG. 11 shows a process 20 that can be implemented to fabricate a ceramic material having one or more of the foregoing properties. In block 21, powder can be prepared. In block 22, a shaped object can be formed from the prepared powder. In block 23, the formed object can be sintered. In block 24, the sintered object can be finished to yield a finished ceramic object having one or more desirable properties.

In implementations where the finished ceramic object is part of a device, the device can be assembled in block 25. In implementations where the device or the finished ceramic object is part of a product, the product can be assembled in block 26.

FIG. 11 further shows that some or all of the steps of the example process 20 can be based on a design, specification, etc. Similarly, some or all of the steps can include or be subjected to testing, quality control, etc.

In some implementations, the powder preparation step (block 21) of FIG. 11 can be performed by the example process described in reference to FIG. 9. Powder prepared in such a manner can include one or more properties as described herein, and/or facilitate formation of ceramic objects having one or more properties as described herein.

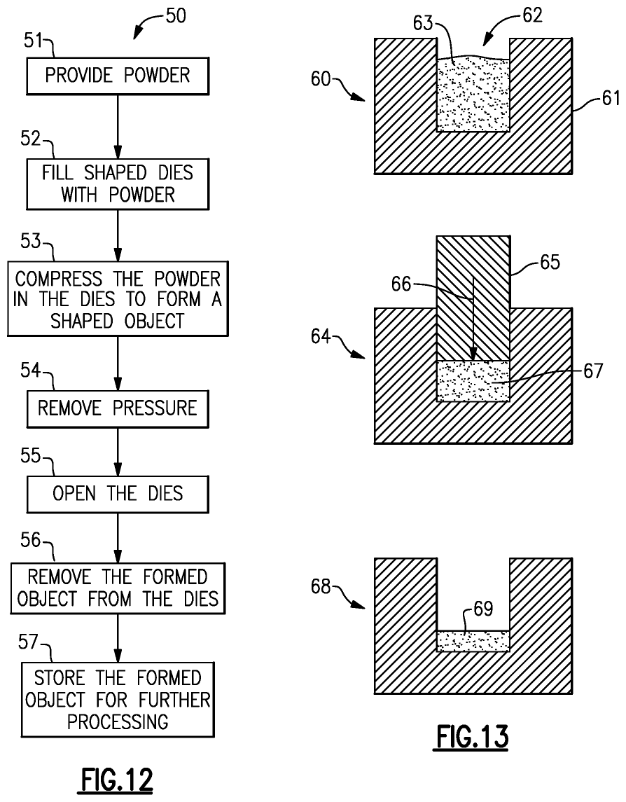

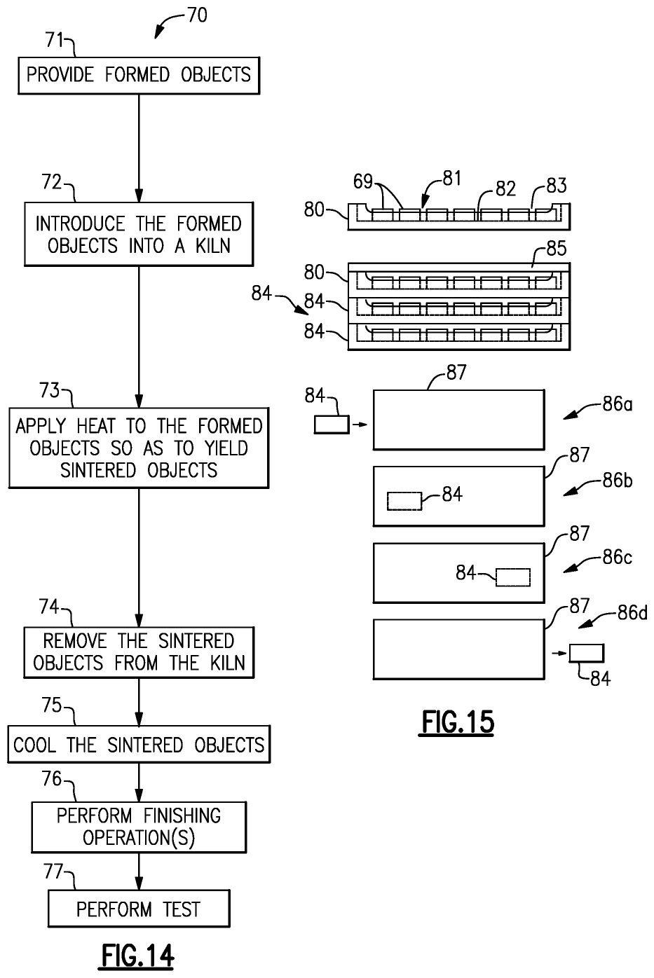

In some implementations, powder prepared as described herein can be formed into different shapes by different forming techniques. By way of examples, FIG. 12 shows a process 50 that can be implemented to press-form a shaped object from a powder material prepared as described herein. In block 52, a shaped die can be filled with a desired amount of the powder. In FIG. 13, configuration 60 shows the shaped die as 61 that defines a volume 62 dimensioned to receive the powder 63 and allow such power to be pressed. In block 53, the powder in the die can be compressed to form a shaped object. Configuration 64 shows the powder in an intermediate compacted form 67 as a piston 65 is pressed (arrow 66) into the volume 62 defined by the die 61. In block 54, pressure can be removed from the die. In block 55, the piston (65) can be removed from the die (61) so as to open the volume (62). Configuration 68 shows the opened volume (62) of the die (61) thereby allowing the formed object 69 to be removed from the die. In block 56, the formed object (69) can be removed from the die (61). In block 57, the formed object can be stored for further processing.

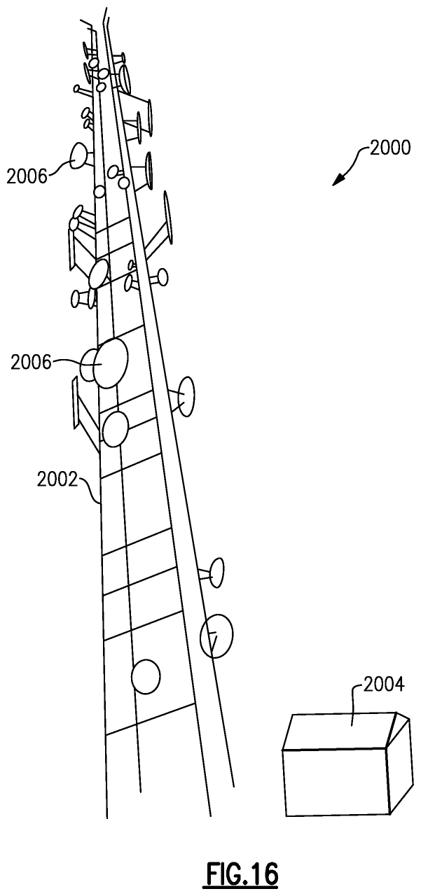

In some implementations, formed objects fabricated as described herein can be sintered to yield desirable physical properties as ceramic devices. FIG. 14 shows a process 70 that can be implemented to sinter such formed objects. In block 71, formed objects can be provided. In block 72, the formed objects can be introduced into a kiln. In FIG. 15, a plurality of formed objects 69 are shown to be loaded into a sintering tray 80. The example tray 80 is shown to define a recess 83 dimensioned to hold the formed objects 69 on a surface 82 so that the upper edge of the tray is higher than the upper portions of the formed objects 69. Such a configuration allows the loaded trays to be stacked during the sintering process. The example tray 80 is further shown to define cutouts 83 at the side walls to allow improved circulation of hot gas at within the recess 83, even when the trays are stacked together. FIG. 15 further shows a stack 84 of a plurality of loaded trays 80. A top cover 85 can be provided so that the objects loaded in the top tray generally experience similar sintering condition as those in lower trays.

In block 73, heat can be applied to the formed objects so as to yield sintered objects. Such application of heat can be achieved by use of a kiln. In block 74, the sintered objects can be removed from the kiln. In FIG. 15, the stack 84 having a plurality of loaded trays is depicted as being introduced into a kiln 87 (stage 86a). Such a stack can be moved through the kiln (stages 86b, 86c) based on a desired time and temperature profile. In stage 86d, the stack 84 is depicted as being removed from the kiln so as to be cooled.

In block 75, the sintered objects can be cooled. Such cooling can be based on a desired time and temperature profile. In block 206, the cooled objects can undergo one or more finishing operations. In block 207, one or more tests can be performed.

Heat treatment of various forms of powder and various forms of shaped objects are described herein as calcining, firing, annealing, and/or sintering. It will be understood that such terms may be used interchangeably in some appropriate situations, in context-specific manners, or some combination thereof.

### Telecommunication Base Station

Circuits and devices having one or more features as described herein can be implemented in RF applications such as a wireless base-station. Such a wireless base-station can include one or more antennas configured to facilitate transmission and/or reception of RF signals.

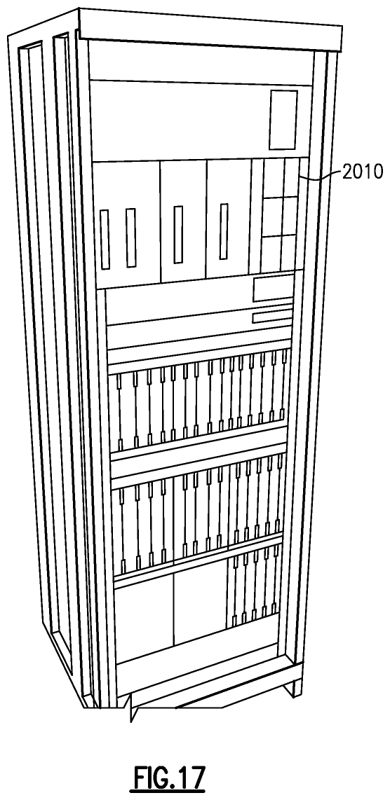

Thus, in some embodiments, the above disclosed material can be incorporated into different components of a telecommunication base station, such as used for cellular networks and wireless communications. An example perspective view of a base station 2000 is shown in FIG. 16, including both a cell tower 2002 and electronics building 2004. The cell tower 2002 can include a number of antennas 2006, typically facing different directions for optimizing service, which can be used to both receive and transmit cellular signals while the electronics building 2004 can hold electronic components such as filters, amplifiers, etc. discussed below. Both the antennas 2006 and electronic components can incorporate embodiments of the disclosed ceramic materials.

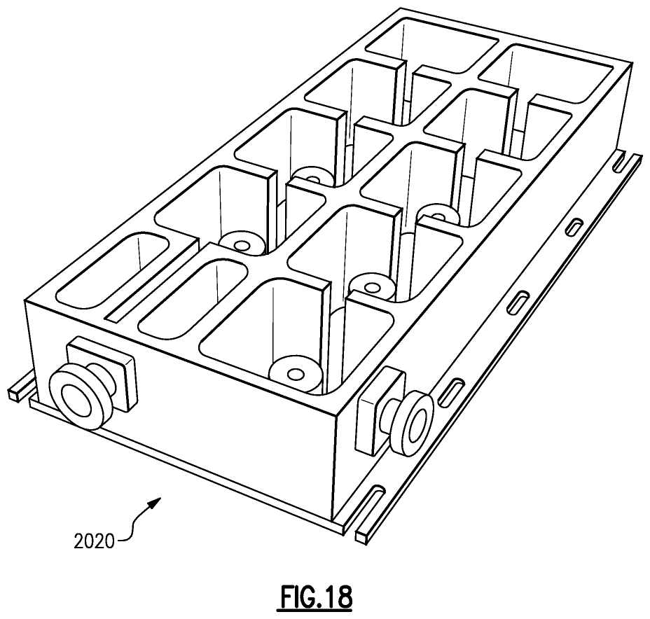

FIG. 17 illustrates hardware 2010 that can be used in the electronics building 2004, and can include the components discussed above with respect to FIG. 10. For example, the hardware 2010 can be a base station subsystem (BSS), which can handle traffic and signaling for the mobile systems.

FIG. 18 illustrates a further detailing of the hardware 2010 discussed above. Specifically, FIG. 18 depicts a cavity filter/combiner 2020 which can be incorporated into the base station. The cavity filter 2020 can include, for example, bandpass filters such as those incorporating embodiments of the disclosed material, and can allow the output of two or more transmitters on different frequencies to be combined.

From the foregoing description, it will be appreciated that an inventive composites and method of manufacturing are disclosed. While several components, techniques and aspects have been described with a certain degree of particularity, it is manifest that many changes can be made in the specific designs, constructions and methodology herein above described without departing from the spirit and scope of this disclosure.

Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as any subcombination or variation of any subcombination.

Moreover, while methods may be depicted in the drawings or described in the specification in a particular order, such methods need not be performed in the particular order shown or in sequential order, and that all methods need not be performed, to achieve desirable results. Other methods that are not depicted or described can be incorporated in the example methods and processes. For example, one or more additional methods can be performed before, after, simultaneously, or between any of the described methods. Further, the methods may be rearranged or reordered in other implementations. Also, the separation of various system components in the implementations described above should not be understood as requiring such separation in all implementations, and it should be understood that the described components and systems can generally be integrated together in a single product or packaged into multiple products. Additionally, other implementations are within the scope of this disclosure.

Conditional language, such as “can,” “could,” “might,” or “may,” unless specifically stated otherwise, or otherwise understood within the context as used, is generally intended to convey that certain embodiments include or do not include, certain features, elements, and/or steps. Thus, such conditional language is not generally intended to imply that features, elements, and/or steps are in any way required for one or more embodiments.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than or equal to 10% of, within less than or equal to 5% of, within less than or equal to 1% of, within less than or equal to 0.1% of, and within less than or equal to 0.01% of the stated amount. If the stated amount is 0 (e.g., none, having no), the above recited ranges can be specific ranges, and not within a particular % of the value. For example, within less than or equal to 10 wt./vol. % of, within less than or equal to 5 wt./vol. % of, within less than or equal to 1 wt./vol. % of, within less than or equal to 0.1 wt./vol. % of, and within less than or equal to 0.01 wt./vol. % of the stated amount.

Some embodiments have been described in connection with the accompanying drawings. The figures are drawn to scale, but such scale should not be limiting, since dimensions and proportions other than what are shown are contemplated and are within the scope of the disclosed inventions. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Additionally, it will be recognized that any methods described herein may be practiced using any device suitable for performing the recited steps.

While a number of embodiments and variations thereof have been described in detail, other modifications and methods of using the same will be apparent to those of skill in the art. Accordingly, it should be understood that various applications, modifications, materials, and substitutions can be made of equivalents without departing from the unique and inventive disclosure herein or the scope of the claims.

What is claimed is:

1. A ceramic article for radio frequency applications, the ceramic article being formed of a composite material comprising:
a matrix phase including Al₂O₃ having a corundum crystal structure; and
a precipitate phase including ZnAl₂O₄ and Zn₂TiO₄ and having a spinel crystal structure.

2. The ceramic article of claim 1 wherein the precipitate phase includes a solid solution of ZnAl₂O₄ and Zn₂TiO₄ having a chemical formula represented by Zn₁₊ₓAl₂₋₂ₓTiₓO₄, and 0≤x≤1.

3. The ceramic article of claim 2 wherein x<0.4.

4. The ceramic article of claim 1 wherein the matrix phase is present at >20 weight % of the composite material.

5. The ceramic article of claim 4 wherein the precipitate phase is present at >40 weight % of the composite material.

6. The ceramic article of claim 1 wherein the precipitate phase has a composition along a ZnAl₂O₄—Zn₂TiO₄ binary solid solution line in a TiO₂—ZnO-Al₂O₃ ternary phase diagram extending between ZnAl₂O₄ and Zn₂TiO₄ end phases.

7. The ceramic article of claim 1 wherein at least some of individual domains of the precipitate phase are isolated from each other and fully enclosed by the matrix phase.

8. The ceramic article of claim 1 wherein the composite material has TiO₂ having a rutile structure in an amount less than 20 weight %.

9. The ceramic article of claim 8 wherein the composite material is substantially free of TiO₂ having a rutile structure.

10. The ceramic article of claim 1 wherein the composite material has Al₂TiO₅ in an amount less than 20 weight %.

11. The ceramic article of claim 1 wherein the composite materials is substantially free of Al₂TiO₅.

12. A radio frequency (RF) circulator comprising:
a ceramic disk formed of a ceramic material having a matrix phase including aluminum oxide having a corundum crystal structure, and a precipitate phase including ZnAl₂O₄ and Zn₂TiO₄ and having a spinel crystal structure.

13. The RF circulator of claim 12 wherein the precipitate phase includes a solid solution of ZnAl₂O₄ and Zn₂TiO₄ having a chemical formula represented by Zn₁₊ₓAl₂₋₂ₓTiₓO₄, and 0≤x≤1.

14. The RF circulator of claim 13 wherein x<0.4.

15. The RF circulator of claim 12 wherein the matrix phase is present at >20 weight % of the ceramic material.

16. The RF circulator of claim 15 wherein the precipitate phase is present at >40 weight % of the ceramic material.

17. The RF circulator of claim 12 wherein the precipitate has a composition along a ZnAl₂O₄—Zn₂TiO₄ binary solid solution line in a TiO₂—ZnO-Al₂O₃ ternary phase diagram extending between ZnAl₂O₄ and Zn₂TiO₄ end phases.

18. A method of forming a ceramic article, the method comprising:
mixing component powders to form a mixed powder;
calcining the mixed powder;
forming the calcined mixed powder into a ceramic disk; and
sintering the ceramic disk such that the ceramic a ceramic material of the ceramic disk includes a matrix phase including aluminum oxide having a corundum crystal structure, and further includes a precipitate phase including ZnAl₂O₄ and Zn₂TiO₄ and having a spinel crystal structure.

19. The method of claim 18 wherein mixing the component powders includes mixing one of ZnAl₂O₄, Zn₂TiO₄ and Zn₁₊ₓAl₂₋₂ₓTiₓO₄ powders with a Al₂O₃ powder.

20. The method of claim 19 wherein mixing the component powders includes further mixing TiO₂

21. The method of claim 19 wherein the ceramic article is a radiofrequency component.
